(19) United States
(12) Patent Application Publication
(10) Pub. No.: US 2020/0356272 A1
(43) Pub. Date: Nov. 12, 2020

(54) WORKLOAD BASED DATA MANAGEMENT

(71) Applicant: Seagate Technology LLC, Cupertino, CA (US)

(72) Inventors: WeiQing Zhou, Singapore (SG); Xiong Liu, Singapore (SG); Feng Shen, Singapore (SG); Kai Chen, Singapore (SG)

(21) Appl. No.: 16/405,752

(22) Filed: May 7, 2019

(51) Int. Cl. G06F 3/06

(52) U.S. Cl. CPC G06F 3/0604; G06F 3/0676; G06F 3/0655

(57) ABSTRACT

An apparatus and system, and methods thereof, include a data storage device and a controller. The data storage device includes a plurality of data storage zones. Each data storage zone includes a plurality of data blocks. The controller includes one or more processors and is operably coupled to the plurality of data storage zones. The controller is configured to determine data storage device workload over a sample time and select the data storage zone for write data to be written to such that a zone performance of the selected data storage zone corresponds to the data storage device workload.

The disclosure herein relates to data management for continuously operating data storage devices and further to systems and methods of the same.

### SUMMARY

An illustrative system may include a data storage device and a controller. The data storage device may include a plurality of data storage zones. Each data storage zone may include a plurality of data blocks. The controller may include one or more processors and may be operably coupled to the plurality of data storage zones. The controller may be configured to determine data storage device workload over a sample time. The controller may also be configured to select the data storage zone for write data to be written to such that a zone performance of the selected data storage zone corresponds to the data storage device workload.

An illustrative apparatus may include a data storage device and a controller. The data storage device may include a plurality of data storage zones. Each data storage zone may include a plurality of data blocks. The controller may include one or more processors and may be operably coupled to the data storage device. The controller may be configured to provide zone performance information for each data storage zone of the plurality of data storage zones and determine data storage device workload. The controller may also be configured to receive write data to be written to the plurality of data storage zones and select the data storage zone for the write data to be written to based on zone performance information and the data storage device workload.

An illustrative method may include providing a data storage device comprising a plurality of data blocks. The method may also include grouping data blocks to form a plurality of data storage zones. Each data storage zone may include data blocks defining a different average throughput. Further, the method may include determining data storage device workload. Also, the method may include selecting the data storage zone for write data to be written to such that a zone performance of the selected data storage zone corresponds to the data storage device workload.

The above summary is not intended to describe each embodiment or every implementation of the present disclosure. A more complete understanding will become apparent and appreciated by referring to the following detailed description and claims taken in conjunction with the accompanying drawings. In other words, these and various other features and advantages will be apparent from a reading of the following detailed description.

### BRIEF DESCRIPTION OF THE DRAWINGS

The disclosure may be more completely understood in consideration of the following detailed description of various embodiments of the disclosure in connection with the accompanying drawings.

FIG. 1 is a schematic view of a data storage device in accordance with embodiments of the present disclosure.

FIG. 2 is a graph illustrating the read/write throughput for various zones of a data storage device.

FIG. 3 is a block diagram of an illustrative system including a controller and a data storage device.

FIG. 4 is a block diagram of an illustrative method of data management in accordance with the illustrative system shown in FIG. 3.

### DETAILED DESCRIPTION

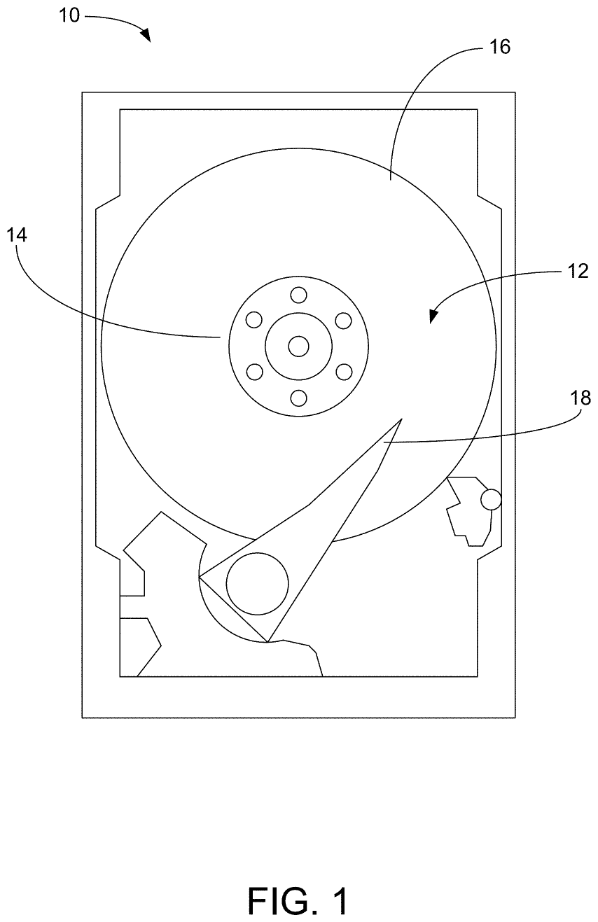

Exemplary systems, apparatus, and methods shall be described with reference to FIGS. 1-4. It will be apparent to one skilled in the art that elements or processes from one embodiment may be used in combination with elements or processes of the other embodiments, and that the possible embodiments of such systems, apparatus, and methods using combinations of features set forth herein is not limited to the specific embodiments shown in the figures and/or described herein. Further, it will be recognized that the size and shape of various elements herein may be modified but still fall within the scope of the present disclosure, although certain one or more shapes and/or sizes, or types of elements, may be advantageous over others.

The present disclosure relates to data management of data storage devices based on the workload of the data storage device for use with, e.g., continuously operating or surveillance applications. Generally, surveillance data storage devices operate continuously for long periods of time. In other words, due to continuous data being recorded to a data storage device (e.g., a magnetic disk or a hard disk drive), the data storage device is constantly writing data to the recording medium. For example, in a continuous recording operation, the system may begin writing to the recording medium at a starting point and continue to write to the recording medium until the recording medium is at full capacity. Thereafter, the controller may return to the starting point to begin the process of writing again. Therefore, the entire recording medium may be utilized (e.g., written to).

A typical hard disk drive may have various levels of performance depending on which portion of the recording medium is being written or read. For example, data throughput (e.g., an amount of data that can be written to or read from the recording medium) of the hard disk drive may be greater proximate the outer diameter than proximate the inner diameter. Specifically, data throughput proximate the outer diameter of the hard disk drive may benefit from a higher operating speed than the inner diameter (e.g., because the recording medium spins at a constant rate and, therefore, a static point proximate the outer diameter covers more area during a full rotation than a static point proximate the inner diameter). Additionally, the outer diameter of the recording medium may include a media cache region (e.g., due to the increased data throughput at the outer diameter) that is accessed frequently and, as a result, seek/track time between the media cache region and other regions proximate the outer diameter may be less than seek/track time between the media cache region and regions proximate the inner diameter. For example, the seek time between a region proximate the outer diameter and another region proximate the outer diameter may take about 5 milliseconds and the seek time between a region proximate the outer diameter and the inner diameter may take about 23 milliseconds. In other words, decreased seek/track time associated with the outer diameter may translate to higher data throughput performance of the outer diameter than compared to the inner diameter.

In current applications, if a hard disk drive is continually writing over a long period of time, the hard disk drive may begin by writing to regions proximate the outer diameter and may progress towards regions proximate the inner diameter until the hard disk drive is full in a single cycle. Because of this progression, the performance may be best (e.g., highest data throughput) at the beginning of the cycle, due to writing to regions proximate the outer diameter, and the performance might be worst (e.g., lowest data throughput) at the end of the cycle, due to writing to regions proximate the inner diameter. As such, the performance may be inadequate for a higher workload towards the end of the cycle (e.g., when writing proximate the inner diameter).

Therefore, it may be desirable to utilize different regions of the recording medium having different performance levels depending on the incoming workload. In other words, it may be desirable to determine which regions of the recording medium should be written to based on the present workload. By dividing the recording medium into multiple zones and each data block within each zone having similar performance levels, a specific zone may be selected for writing data based on present workload of the system. For example, when the system is experiencing a high workload (e.g., due to an increased number of reading/writing), data can be written to a zone having higher performance and when the system is experiencing a low workload (e.g., due to a decreased number of reading/writing), data can be written to a zone having lower performance. Specifically, for a hard disk drive being utilized for surveillance applications, a higher workload may be the result of increased sampling or resolution (e.g., during daytime hours) and a lower workload may be the result of decreased sampling or resolution (e.g., during nighttime hours). By specifically allocating data to different zones based on present workload, the overall performance of the hard disk drive may be improved or optimized. Further, because the zone performance (e.g. data throughput) of the inner diameter may be about half the zone performance of the outer diameter, managing write data based on incoming workload and zone performance may result in higher and more consistent performance than current data recording.

Reference will now be made to the drawings, which depict one or more aspects described in this disclosure. However, it will be understood that other aspects not depicted in the drawings fall within the scope and spirit of this disclosure. Like numbers used in the figures refer to like components, elements, portions, regions, openings, apertures, and the like. However, it will be understood that the use of a reference character to refer to an element in a given figure is not intended to limit the element in another figure labeled with the same reference character.

FIG. 1 illustrates an exemplary data storage device 10 (e.g., a magnetic disk or a hard disk drive). The data storage device 10 may include any suitable type of data storage device 10. For example, the data storage device 10 may define any form factor, capacity size, and/or interface connection. The data storage device 10 may include a recording surface 12 defining a circular shape (e.g., annular shape) and extending between an inner diameter 14 and an outer diameter 16. The recording surface 12 of the data storage device 10 may be written to or read from by a read/write head assembly 18. It is noted that the inner and outer diameters 14, 16 may refer to portions of the recording surface 12 that may be used in the applications as described herein and may not necessarily refer to portions dedicated to, e.g., media cache, systems zones, spare zones, metadata zones, etc. Further, in one or more embodiments, the data storage device 10 may include any suitable number of recording surfaces.

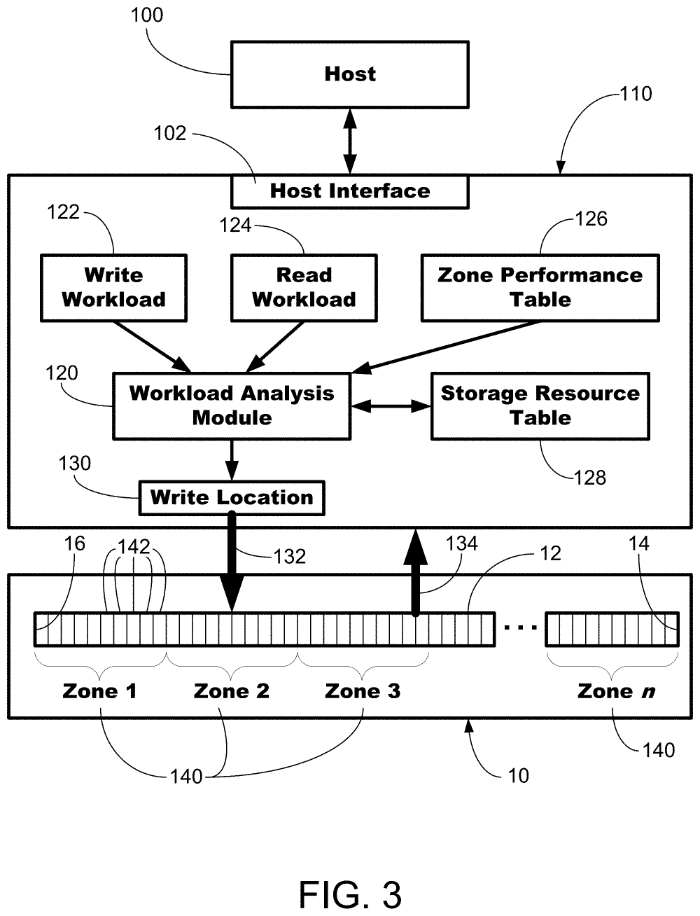

The recording surface 10 may be divided into a plurality of data storage zones 140 and each data storage zone 140 may include any devices, circuits, and/or apparatus configured to store a plurality of data blocks 141 (e.g., as shown in FIG. 3). The plurality of data blocks 141 may be configured to be written to 132 and/or read from 134. In one or more embodiments, the plurality of data blocks 141 may be contained in non-volatile data storage. Non-volatile data storage may include any kind of computer memory that can retain information stored thereon when not powered. Examples of non-volatile memory that may be utilized as the non-volatile main memory include, but are not limited to, read only memory (ROM), flash memory, hard drives, and random-access memory (RAM). Examples of ROM include, but are not limited to, programmable ROM (PROM) which can also be referred to as field programmable ROM; electrically erasable programmable ROM (EEPROM) which is also referred to as electrically alterable ROM (EAROM); and erasable programmable ROM (EPROM). Examples of RAM include, but are not limited to, ferroelectric RAM (FeRAM or FRAM); magnetoresistive RAM (MRAM); resistive RAM (RRAM); non-volatile static RAM (nvSRAM); battery backed static RAM (BBSRAM); phase change memory (PCM) which is also referred to as PRAM, PCRAM and C-RAM; programmable metallization cell (PMC) which is also referred to as conductive-bridging RAM or CBRAM; nano-RAM (NRAM), spin torque transfer RAM (STTRAM) which is also referred to as STRAM; and Silicon-Oxide-Nitride-Oxide-Silicon (SONOS), which is similar to flash RAM.

The plurality of data storage zones 140 may be arranged on the recording surface 10 in any suitable way. For example, in one or more embodiments, the plurality of data storage zones 140 may be defined by areas of concentric circles extending around the recording surface 10. Specifically, the recording surface 10 may define a data storage zone 140 (e.g., zone 1 illustrated in FIG. 3) at or most proximate to the outer diameter 16, a data storage zone 140 (e.g., zone n illustrated in FIG. 3) at or most proximate to the inner diameter 14, and data storage zones 140 therebetween. The recording surface 10 may define any suitable number of data storage zones 140. For example, the plurality of data storage zones 140 may include about 5 to about 50 data storage zones. Specifically, the plurality of data storage zones 140 may include about 20 data storage zones.

The recording surface 10 may be divided into the plurality of data storage zones 140 in any suitable way. For example, each data storage zone 140 may define a similar storage capacity (e.g., a similar surface area). Also, for example, each data storage zone 140 may define an average data throughput for writing to that particular data storage zone 140. Because each data storage zone 140 may be located at different regions of the recoding surface 10 (e.g., closer to the outer diameter 16 than the inner diameter 14 or closer to the inner diameter 14 than the outer diameter 16), each data storage zone 140 may define a different data throughput than another data storage zone 140.

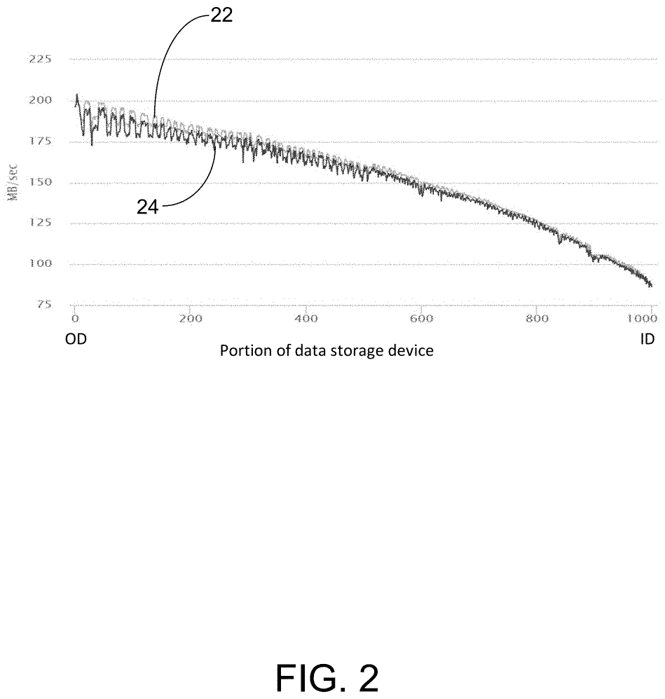

The data throughput (e.g., measured in megabytes per second (MB/s)) varies depending on the location of the data storage zone 140 (e.g., relative to the inner diameter 14 and the outer diameter 16). FIG. 2 illustrates data points for 1,000 different portions of data storage blocks ranging from portion 1 located at the outer diameter (OD) and portion 1,000 located at the inner diameter (ID). These data points were measured over a test time of about 7.6 hours and range from a data throughput of about 195 MB/s at portion 1 to about 90 MB/s at portion 1,000. The data trend lines (read speed 22 and write speed 24) indicate that the fastest data throughput occurs at portions nearest the outer diameter and the slowest data throughput occurs at portions nearest the inner diameter (e.g., with the data throughput following a generally linear trajectory for data storage zones therebetween). As described herein, these portions may be grouped together to form a plurality of data storage zones 140. Further, for example, each data storage zone 140 may include a minimum data throughput and a maximum data throughput. In one or more embodiments, the plurality of data storage zones 140 may be defined such that the minimum data throughput and the maximum data throughput of a data storage zone 140 is within about 5 MB/s to about 30 MB/s of one another. Specifically, the plurality of data storage zones 140 may be defined such that the minimum data throughput and the maximum data throughput of a data storage zone 140 is within about 20 MB/s of one another.

An exemplary system, or apparatus, that can be used in the embodiments described herein are illustrated in FIG. 3. For example, the system may further include a controller 110 operably coupled to the data storage device 10. Further, the controller 110 may also be operably coupled to a host 100, e.g., for transferring data therebetween. For example, the host 100 may request data from the controller 110, and in turn, the controller 110 may provide such requested data to the host 100. The controller 110 may include various circuitry, logic, memory, etc. for use in reading, writing, moving, erasing, etc. data from the data storage device 10. For example, the controller 110 may include one or more circuit components such as integrated circuits, processors, etc. that may be configured to interface with the data storage device 10 (e.g., to read 134 and write 132 data) and the host 100. The controller 110 may be operably coupled to the host 100 through the host interface 102. The host interface 102 may include any suitable interface (such as, e.g., serial advanced technology attachment (SATA), serial attached small computer system interface (SAS), peripheral component interconnect express (PCIe), non-volatile memory express (NVMe) etc.) In one or more embodiments, the host 100 may be a computer (such as, e.g., a personal computer, server, etc.). Although a single host device is depicted, it is to be understood a plurality of host devices 100 may be operably coupled to the controller 110. Further, in one or more embodiments, multiple controllers 110 and/or data storage devices 10 may be operably coupled to a single host 100.

The methods and/or logic described in this disclosure, including those attributed to the system or apparatus, or various constituent components (e.g., the controller 110), may be implemented, at least in part, in hardware, software, firmware, or any combination thereof. For example, various aspects of the techniques may be implemented within one or more processors, including one or more microprocessors, microcontrollers, DSPs, ASICs, FPGAs, or any other equivalent integrated or discrete logic circuitry, as well as any combinations of such components, or other devices. The term “processor” or “processing circuitry” may generally refer to any of the foregoing logic circuitry, alone or in combination with other logic circuitry, or any other equivalent circuitry. Such hardware, software, and/or firmware may be implemented within the same system or within separate systems to support the various operations and functions described in this disclosure. In addition, any of the described components may be implemented together or separately as discrete but interoperable logic devices.

When implemented in software, the functionality ascribed to the systems, devices and methods described in this disclosure may be embodied as instructions and/or logic on a computer-readable medium such as RAM, ROM, NVRAM, EEPROM, FLASH memory, magnetic data storage media, optical data storage media, or the like. The instructions and/or logic may be executed by one or more processors to support one or more aspects of the functionality described in this disclosure.

The controller 110 may be configured to analyze multiple factors to determine the best data storage zone 140 to which data is written at a specific time. For example, the controller 110 may be configured to provide zone performance information for each data storage zone of the plurality of data storage zones 140. Specifically, the zone performance may be determined based on the data throughput capabilities for a specific data storage zone 140 (e.g., as shown in FIG. 2). The zone performances for the plurality of data storage zones 140 may range from a minimum performance level to a maximum performance level. For example, the maximum performance level may define a higher data throughput of the data storage device 10 than the minimum performance level. Further, the maximum performance level may be located proximate the outer diameter 16 of the data storage device 10 and the minimum performance level may be located proximate the inner diameter 14 of the data storage device 10.

Further, the zone performance of each data storage zone 140 may be collected in any suitable way. For example, in one or more embodiments, the plurality of data storage zones 140 may be tested during the manufacturing and/or certification process to determine the data throughput for each data storage zone and, therefore, the corresponding zone performance. In other embodiments, a curve fit may be used to build a transfer function between data throughput and the data storage zones 140. In yet other embodiments, the data throughput of the plurality of data storage zones 140 may be calculated or measured during operation of the data storage device 10 (and, e.g., stored by the controller 110). For example, during a drive idle stage (e.g., when there is reduced read/write activity), the controller 110 may collect data pertaining to the zone performance. Therefore, the controller 110 may update the zone performance information during use because, e.g., the zone performance may change over long periods of time.

The zone performance information for the plurality of data storage zones 140 may be accessible by the controller 110 in any suitable way. For example, in one or more embodiments, the controller 110 may include a zone performance table 126, as shown in FIG. 3. The zone performance table 126 may store the zone performance information (e.g., determined during manufacturing/testing or during operation) to be readily accessible by the controller 110. Specifically, in one or more embodiments, the zone performance table 126 may be stored to, e.g., dynamic random-access memory (DRAM), drive media, flash memory, or any other type of non-volatile memory.

The controller 110 may also be configured to determine data storage device workload. In other words, the controller 110 may determine the workload (e.g., the amount of data being processed through the host) on the data storage device 10 at a specific time. The workload of the data storage device 10 may vary depending on a number of different parameters. For example, in a data storage device 10 conducting surveillance operations, the workload may be greater due to higher sampling rate, higher resolution, higher bit rate, compression quality, increased use of video analytics (e.g., to analyze content of the video), more metadata, etc. Specifically, in some embodiments, these parameters (e.g., attributed to higher workload) may be more present during the day because there may be an increased amount of “action” to record. Also, in a data storage device conducting surveillance operations, the workload may be lower due to lower sampling rate, lower resolution, lower bit rate, compression quality, decreased use of video analytics, less metadata, etc. Specifically, in some embodiments, these parameters (e.g., attributed to lower workload) may be more present during the night. In one or more embodiments, a surveillance system may include a motion detector for which the recording rate and resolution may be increased after triggering the sensor, thereby increasing the workload on the data storage device 10. It may be described that the data storage device workload may range from a minimum (e.g., during times of low data throughput) to a maximum (e.g., during times of high data throughput).

Further, the workload may generally include multiple different components. For example, the workload may include a write workload 122 (e.g., from the host 100), a read workload 124 (e.g., to the host 100), and/or a seek/track time workload (e.g., across the recording surface 12), etc. Specifically, the number of write or read operations and the amount of seek/track time may factor into the overall workload of the data storage device 10.

The data storage device workload may be calculated in a variety of different ways. For example, in one or more embodiments, the data storage device workload may be an instant or present data throughput experienced by the controller. In other embodiments, the data storage device workload may be calculated by taking an average data storage device workload over a sample time. For example, the sample time may be about 5 minutes to about 60 minutes. Specifically, the sample time may be about 10 minutes. In other embodiments, the data storage device workload may be determined purely based on the time of day (e.g., determined to have higher workload during the day and lower workload during the night). In yet other embodiments, the data storage device workload may be determined or provided by the host. For example, the host may follow a protocol such as, e.g., instructing the drive what the expected workload is based on other input parameters available to the host.

The controller 110 may be further configured to receive write data to be written to the plurality of data storage zones 140. Thereafter, the controller 110 may be configured to select the data storage zone 140 for the write data to be written to such that the selection of the specific data storage zone 140 may be based on the zone performance and the data storage device workload. In other words, the controller 110 may consider the data storage device workload and the zone performance information when considering and selecting which data storage zone 140 is most appropriate for the present write data. Specifically, the controller 110 may include a workload analysis module 120 to determine a write location 130 (e.g., the best data storage zone) for specific write data based on the factors (e.g., zone performance information, data storage device workload, etc.) input into the workload analysis module 120.

Further, the controller 110 (e.g., via the workload analysis module 120) may be configured to select the data storage zone 140 for the write data to be written to such that a zone performance of the selected data storage zone 140 corresponds to the data storage device workload. For example, a specific zone performance (e.g., of a data storage zone 140) may match or correspond to a specific data storage device workload when selecting a location to write data. Specifically, during a maximum data storage workload, write data may be written to a data storage zone 140 having a higher zone performance instead of a lower zone performance. Alternatively, during a minimum data storage workload, write data may be written to a data storage zone 140 having a lower zone performance instead of a higher zone performance. Put another way, write data may be written to a data storage zone having a higher zone performance during a maximum data storage workload than during a minimum data storage workload. Alternatively, write data may be written to a data storage zone having a lower zone performance during a minimum data storage workload than during a maximum data storage workload.

More specifically, either of the zone performance of a data storage zone or the data storage device workload may be based on a percentage of the maximum value of either the zone performance or data storage device workload. These values may then be mapped to one another between the zone performance and the data storage device workload. For example, if the data storage device workload is presently 20%, 40%, 60%, or 80% of the maximum workload, any incoming write data may be allocated to a data storage zone having a zone performance of 20%, 40%, 60%, or 80% of the maximum performance, respectively. It is noted that the data storage device workload values may be mapped to the zone performance values in any suitable way.

In addition to selecting the appropriate data storage zone 140 for write data to be written, the controller 110 may also be configured to monitor the data storage zones 140 to ensure that there is sufficient space for additional write operations to a specific data storage zone 140. Therefore, the process of selecting the data storage zone 140 for the write data to be written may also be based on zone availability information. In other words, the workload analysis module 120 may also consider the zone availability information when selecting the write location 130. As such, in one or more embodiments, selecting the data storage zone 140 for write data to be written to may be based on zone performance information, data storage device workload, and zone availability information. The zone availability information may include information regarding whether data can be written to a specific data storage zone.

The zone availability information for the plurality of data storage zones 140 may be accessible by the controller 110 in any suitable way. For example, in one or more embodiments, the controller 110 may include a storage resource table 128, as shown in FIG. 3. The storage resource table 126 may store the zone availability information (e.g., actively determined during operation) to be readily accessible by the controller 110.

If a specific data storage zone 140 is determined to be “full,” the controller 110 may begin to allocate future write operations to a different data storage zone. Further, during times of lower or minimum data storage device workload, the controller 110 may transfer data located at data storage zones 140 having higher performance zones (e.g., proximate the outer diameter 16) to data storage zones having lower performance zones (e.g., proximate the inner diameter 14). In other words, the controller 110 may conduct a form of garbage collection to help free up data storage zones having higher performance zones. This garbage collection operation may occur when a data storage zone having a higher zone performance is about to be fully consumed (and, e.g., needs to be freed up) or during “slow” times of lower workload.

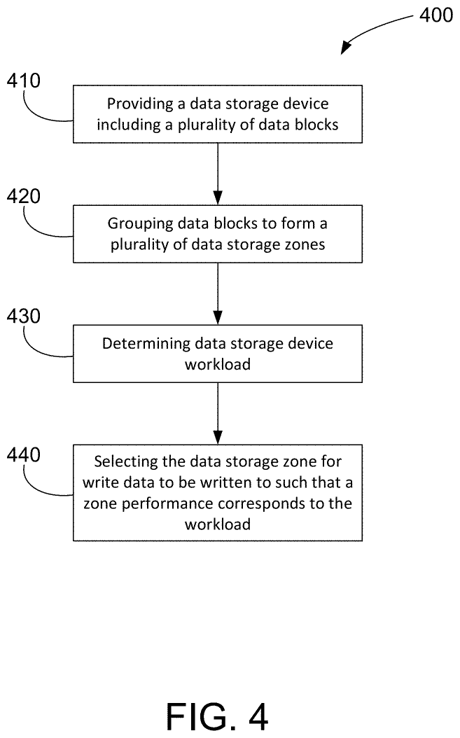

Furthermore, an illustrative method 400 of managing data based on workload and zone performance is illustrated in FIG. 4. For example, the method 400 may include providing 410 a data storage device including a plurality of data blocks. The method 400 may also include grouping 420 data blocks to form a plurality of data storage zones. Each data storage zone may include data blocks defining a different average throughput. Further, the method 400 may include determining 430 data storage device workload and selecting 440 the data storage zone for write data to be written to such that a zone performance of the selected data storage zone corresponds to the data storage device workload, as described herein. In one or more embodiments, the method 400 may also include providing zone performance for each data storage zone of the plurality of data storage zones.

In the preceding description, reference is made to the accompanying set of drawings that form a part hereof and in which are shown by way of illustration several specific embodiments. It is to be understood that other embodiments are contemplated and may be made without departing from (e.g., still falling within) the scope or spirit of the present disclosure. The preceding detailed description, therefore, is not to be taken in a limiting sense. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise. As used herein, “or” is generally employed in its sense including “and/or” unless the content clearly dictates otherwise. As used herein, “have,” “having,” “include,” “including,” “comprise,” “comprising,” or the like are used in their open-ended sense, and generally mean “including, but not limited to.”

Embodiments of the systems, apparatus, and methods associated therewith are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation, and the present disclosure is limited only by the claims that follow.

What is claimed is:

1. A system comprising:
a data storage device comprising a plurality of data storage zones, each data storage zone comprising a plurality of data blocks;
a controller comprising one or more processors, the controller operably coupled to the plurality of data storage zones and configured to:
determine data storage device workload over a sample time,
select the data storage zone for write data to be written to such that a zone performance of the selected data storage zone corresponds to the data storage device workload.

2. The system of claim 1, wherein the controller is further configured to receive write data to be written to the plurality of data storage zones prior to selecting the data storage zone.

3. The system of claim 1, wherein the controller is further configured to provide zone performance for each data storage zone of the plurality of data storage zones.

4. The system of claim 1, wherein the zone performances for the plurality of data storage zones range from a minimum performance level to a maximum performance level, wherein the maximum performance level defines a higher data throughput of the data storage device than the minimum performance level.

5. The system of claim 1, wherein the data storage device workload ranges from a minimum to a maximum, wherein write data is written to a data storage zone having a higher performance during the maximum data storage workload than during the minimum data storage workload

6. The system of claim 1, wherein each data storage zone defines a similar storage capacity.

7. An apparatus comprising:
a data storage device comprising a plurality of data storage zones, each data storage zone comprising a plurality of data blocks;
a controller comprising one or more processors, the controller operably coupled to the data storage device and configured to:
provide zone performance information for each data storage zone of the plurality of data storage zones,
determine data storage device workload,
receive write data to be written to the plurality of data storage zones, and
select the data storage zone for the write data to be written to based on zone performance information and the data storage device workload.

8. The apparatus of claim 7, wherein selecting the data storage zone for the write data to be written comprises selecting the data storage zone defining a zone performance corresponding to the data storage device workload.

9. The apparatus of claim 7, wherein selecting the data storage zone for the write data to be written is also based on zone availability information.

10. The apparatus of claim 7, wherein the zone performances for the plurality of data storage zones range from a minimum performance level to a maximum performance level, wherein the maximum performance level defines a higher data throughput of the data storage device than the minimum performance level.

11. The apparatus of claim 10, wherein the data storage device comprises a recording surface extending between an outer diameter and an inner diameter, wherein the maximum performance level is located proximate the outer diameter of the recording surface and the minimum performance level is located proximate the inner diameter of the recording surface.

12. The apparatus of claim 7, wherein the data storage device workload ranges from a minimum to a maximum, wherein write data is written to a data storage zone having a higher performance during the maximum data storage workload than during the minimum data storage workload

13. The apparatus of claim 7, wherein determining the data storage device workload comprises calculating an average data storage workload over a sample time.

14. The apparatus of claim 13, wherein the sample time is about 10 minutes.

15. The apparatus of claim 7, wherein each data storage zone defines a similar storage capacity.

16. A method comprising:
providing a data storage device comprising a plurality of data blocks;
grouping data blocks to form a plurality of data storage zones, each data storage zone including data blocks defining a different average throughput;
determining data storage device workload;
selecting the data storage zone for write data to be written to such that a zone performance of the selected data storage zone corresponds to the data storage device workload.

17. The method of claim 16, further comprising providing zone performance for each data storage zone of the plurality of data storage zones.

18. The method of claim 16, wherein each data storage zone comprises a minimum data throughput and a maximum data throughput, wherein the minimum data throughput and the maximum data throughput of each data storage zone is within 20 MB/s of one another.

19. The method of claim 16, wherein the zone performances for the plurality of data storage zones range from a minimum performance level to a maximum performance level, wherein the maximum performance level defines a higher data throughput of the data storage device than the minimum performance level.

20. The method of claim 16, wherein determining the data storage device workload comprises calculating an average data storage workload over a sample time.
